(19) United States
(12) Patent Application Publication
(10) Pub. No.: US 2018/0236436 A1
(43) Pub. Date: Aug. 23, 2018

(54) LIQUID PURIFICATION USING ACTIVATED CARBON

(71) Applicant: Cabot Corporation, Boston, MA (US)

(72) Inventors: Gerald D. Adler, Charlestown, MA (US); Susnata Samanta, Medford, MA (US)

(73) Assignee: Cabot Corporation, Boston, MA (US)

(21) Appl. No.: 15/752,049

(22) PCT Filed: Aug. 3, 2016
(86) PCT No.: PCT/US2016/045300

§ 371 Date: Feb. 12, 2018

Related U.S. Application Data
(60) Provisional application No. 62/205,187, filed on Aug. 14, 2015.

(51) Int. Cl. B01J 20/20; B01J 20/28; C01B 32/312; C02F 1/28

(52) U.S. Cl. CPC B01J 20/20; B01J 20/28004; C02F 2103/007; C02F 1/283; C01B 32/312

(57) ABSTRACT

Disclosed herein are methods liquid (e.g., water) purification using activated carbon.

### RELATED APPLICATION

This application claims priority under 35 U.S.C. § 119(e) to U.S. Prov. App. No. 62/205,187, filed Aug. 14, 2015, hereby incorporated by reference.

### FIELD OF THE INVENTION

Disclosed herein are methods of liquid purification using activated carbon.

### BACKGROUND

Liquids are often purified for a variety of reasons. For example, water from a lake or a reservoir may be purified to make it potable, i.e., fit for human consumption. As another example, waste water or water from an industrial process may be purified prior to being discharged to the environment.

### SUMMARY

In one aspect, the invention features a method of purification, including contacting (a) activated carbon and (b) water or a liquid selected to be purified, wherein the activated carbon has a d₉₅ particle size distribution ranging from 1 μm to 28 μm and a d₉₅/d₅₀ ratio ranging from 1.5 to 3.

Without wishing to be bound by any theory, the small particle size activated carbons disclosed herein can enhance liquid or water purification due to its having a high specific external surface area. In embodiments in which the contact time between the activated carbon and the liquid is very short, there is insufficient time for impurities in the liquid to adsorb to internal surfaces of the activated carbon (i.e., surface area deep inside the pores of the activated carbon). Reducing the size of the activated carbon, such as by reducing the d₉₅ particle size, increases the specific external surface area of an activated carbon, thereby improving the activated carbon's ability to remove impurities.

### DETAILED DESCRIPTION

Disclosed herein are methods of liquid or water purification using small particle size activated carbon.

The liquid or water to be purified can come from a variety of sources. Typically, the liquid or water selected to be purified contains one or more substances, such as impurities and contaminants, that a user wants to remove from the liquid or water. The water to be purified can come from a surface water body, such as a lake, a pond, a stream, or a reservoir, or from below ground, such as from a well. In some embodiments, after purification, the water is potable, i.e., fit for human consumption according to applicable standards. The water to be purified can be waste water, or process water, such as water from an industrial process. In some embodiments, after purification, the water is suitable to be discharged into the environment, for example, the impurity levels are at or below environmental standards and regulations.

The substances to be removed from the liquid or water to be purified can also vary. An example of a substance is a micropollutant, such as a pharmaceutical agent, an X-ray contrasting agent, a polymeric product, a cosmetic-related substance, a personal care-related substance, hydrocarbons, a hormone, a pesticide, an insecticide, a metal, and a radioactive substance. Other examples of substances include total organic carbons (TOCs), and taste and odor causing compounds (such as 2-methylisoborneol (MIB) and geosmin). Additional examples of substances include natural organic matter, biodegradable organic compounds, disinfection by-products (such as chlorine and chloramine), ammonia, suspended matter, residual oxidizing agents (such as ozone and peroxides), toxins, and inhibitory compounds.

In certain embodiments, the activated carbon has a small a ratio of d₉₅ to d₅₀, e.g., a d₉₅/d₅₀ ratio ranging from 1.5 to 3. In some embodiments, the activated carbon has a d₉₅/d₅₀ ratio ranging, e.g., from 2 to 3 or from 2.5 to 3. D₉₅ represents the particle size of 95% of the particle population on a volume basis, d₅₀ represents the particle size of 50% of the particle population on a volume basis, and similarly for d₉₀.and d_{99.9}. Particle size can be determined by any method known in the art, such as an LS™ 13 320 or an LS™ 200 Laser Diffraction Particle Size Analyzer, both available from Beckman Coulter.

Some embodiments provide activated carbon having a d₉₅ particle size distribution ranging from 1 μm to 28 μm, e.g., from 1 μm to 27 μm, from 1 μm to 26 μm, from 1 μm to 25 μm, from 1 μm to 23 μm, from 1 μm to 20 μm, from 1 μm to 18 μm, from 1 μm to 15 μm, from 1 μm to 10 μm, from 3 μm to 28 μm, from 3 μm to 27 μm, from 3 μm to 26 μm, from 3 μm to 25 μm, from 3 μm to 23 μm, from 3 μm to 20 μm, from 3 μm to 18 μm, from 3 μm to 15 μm, 3 μm to 10 μm, from 5 μm to 28 μm, from 5 μm to 27 μm, from 5 μm to 26 μm, from 5 μm to 25 μm, from 5 μm to 23 μm, from 5 μm to 20 μm, from 5 μm to 18 μm, from 5 μm to 15 μm, or from 5 μm to 10 μm.

In certain embodiments, the activated carbon has a particle size distribution characterized by a mean or d₅₀ particle size distribution ranging from 1 μm to 18 μm, e.g., from 1 μm to 15 μm, from 1 μm to 13 μm, from 1 μm to 10 μm, from 3 μm to 18 μm, from 3 μm to 15 μm, from 3 μm to 13 μm, from 3 μm to 10 μm, from 4 μm to 18 μm, from 4 μm to 15 μm, from 4 μm to 13 μm, from 4 μm to 10 μm, from 5 μm to 18 μm, from 5 μm to 15 μm, from 5 μm to 13 μm, from 5 μm to 10 μm, from 8 μm to 18 μm, from 8 μm to 15 μm, from 8 μm to 13 μm, from 9 μm to 18 μm, from 9 μm to 15 μm, or from 9 μm to 13 μm.

In some embodiments, the activated carbon has a particle size distribution characterized by a d₉₀ particle size distribution ranging from 1 μm to 20 μm, e.g., from 1 μm to 15 μm, from 1 μm to 12 μm, from 1 μm to 10 μm, from 3 μm to 20 μm, from 3 μm to 15 μm, from 3 μm to 12 μm, from 3 μm to 10 μm, from 5 μm to 20 μm, from 5 μm to 15 μm, from 5 μm to 12 μm, or from 5 μm to 10 μm.

In other embodiments, the activated carbon has a particle size distribution characterized by a d_{99.9} particle size distribution ranging from 1 μm to 15 μm, e.g., from 1 μm to 15 μm, from 1 μm to 12 μm, from 1 μm to 10 μm, from 3 μm to 15 μm, from 3 μm to 12 μm, from 3 μm to 10 μm, from 5 μm to 15 μm, from 5 μm to 12 μm, or from 5 μm to 10 μm.

Methods of preparing the activated carbon disclosed herein, as well as other embodiments of the activated carbon, are disclosed in U.S. Published Patent Application No. 2015-0202594A1, hereby incorporated by reference.

The feedstock for the activated carbon can be any activated carbon obtained by carbonizing/activating (which may occur separately or concurrently, e.g., via steam, gas, and/or chemical treatment at high temperature, such as in a kiln) a raw material as a carbonaceous source. In one embodiment, useful activated carbons can be any obtained from raw materials selected from peat, wood, lignocellulosic materials, biomass, waste, tire, olive pits, peach pits, corn hulls, rice hulls, petroleum coke, lignite, brown coal, anthracite coal, bituminous coal, sub-bituminous coal, coconut shells, pecan shells, and walnut shells, and other raw materials known in the art. These raw materials can be carbonized and activated (e.g., steam activation, gas activation, or chemical activation) to form the activated carbon feedstock. In one embodiment, the activated carbons disclosed herein are lignite-based activated carbons or bituminous coal-based activated carbons (e.g., derived from lignite or bituminous coal).

In use, the activated carbon disclosed herein and the liquid or water to be purified are contacted together to purify the liquid or water. In some embodiments, the liquid or water to be purified is dosed with a preselected quantity of activated carbon disclosed herein for a time sufficient to achieve a desired purification (e.g., to provide potable water, or to provide dischargeable liquid or water). In other embodiments, the liquid or water to be purified is flowed through the activated carbon (e.g., in a bed, or in a filter canister) to achieve purification. The purification contact time can be on the order of minutes (e.g. 30 to 90 minutes), hours, or days. The purification can be performed, for example, in a residential setting, in a municipal waste water treatment plant, or in an industrial setting.

The liquid to be purified can be mainly water, or water can be a minor component of the liquid. In some embodiments, the liquid to be purified contains more than 50% by volume of water, more than 60% by volume of water, more than 70% by volume of water, more than 80% by volume of water, more than 90% by volume of water, or more than 95% by volume of water. In some embodiments, the liquid to be purified consists of or consists essentially of water. In other embodiments, the liquid to be purified contains less than 50% by volume of water, less than 40% by volume of water, less than 30% by volume of water, less than 20% by volume of water, less than 10% by volume of water, or less than 5% by volume of water.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A method of purification, comprising:
contacting (a) activated carbon and (b) water or a liquid selected to be purified,
wherein the activated carbon has a d₉₅ particle size distribution ranging from 1 μm to 28 μm and a d₉₅/d₅₀ ratio ranging from 1.5 to 3.

2. The method of claim 1, wherein the activated carbon has a d₉₅/d₅₀ ratio ranging from 2 to 3.

3-6. (canceled)

7. The method of claim 1, wherein the activated carbon has a d₉₅ particle size distribution ranging from 5 μm to 26 μm.

8. (canceled)

9. (canceled)

10. The method of claim 1, wherein the activated carbon has a d₅₀ particle size distribution ranging from 1 μm to 18 μm.

11-13. (canceled)

14. The method of claim 1, wherein the activated carbon has a d₅₀ particle size distribution ranging from 8 μm to 18 μm

15. (canceled)

16. The method of claim 1, wherein the activated carbon has a d₉₀ particle size distribution ranging from 1 μm to 13 μm.

17. The method of claim 1, wherein the activated carbon has a d_{99.9} particle size distribution ranging from 5 μm to 15 μm.

18. The method of claim 1, wherein the activated carbon is formed from a raw material selected from peat, wood, lignocellulosic materials, biomass, waste, tire, olive pits, peach pits, corn hulls, rice hulls, petroleum coke, lignite, brown coal, anthracite coal, bituminous coal, sub-bituminous coal, coconut shells, pecan shells, and walnut shells.

19. The method of claim 1, wherein the activated carbon is a lignite-based activated carbon.

20. The method of claim 1, wherein the activated carbon is a bituminous coal-based activated carbon.

21. The method of claim 1, wherein the contacting is performed for a time sufficient to reduce a concentration of a selected substance in the water from a first concentration to a targeted concentration.

22. The method of claim 1, wherein the substance is selected from the group consisting of a micropollutant, an organic compound, a taste and odor compound, and a microtoxin.

23. The method of claim 22, wherein the micropollutant is selected from the group consisting of a pharmaceutical compound, an X-ray contrasting agent, a cosmetic product, a personal care product, a hydrocarbon, a hormone, a polymeric product, a pesticide, an insecticide, a metal, and a radioactive agent.

24. The method of claim 1, wherein, after contacting with the activated water, the water is potable.

25. The method of claim 1, wherein the water is selected from the group consisting of surface water, waste water, and process water.
